(19) United States
(12) Patent Application Publication
(10) Pub. No.: US 2005/0258720 A1
(43) Pub. Date: Nov. 24, 2005

(54) Suspending device

(75) Inventor: Werner Camps, Antwerpen (BE)

Correspondence Address: SIMPSON & SIMPSON, PLLC, 5555 MAIN STREET, WILLIAMSVILLE, NY, 14221-5406, US

(73) Assignee: Conteyor Multibag Systems N.V., Merelbeke (BE)

(21) Appl. No.: 11/136,847

(22) Filed: May 25, 2005

Related U.S. Application Data
(63) Continuation of application No. PCT/EP03/50825, filed on Nov. 13, 2003.

(30) Foreign Application Priority Data
Nov. 27, 2002 (DE) 20218442.0

(51) Int. Cl. B42F 15/00

(52) U.S. Cl. 312/184

(57) ABSTRACT

A suspension device which can be fixed and also released again in a simple manner to and from a profiled bar or the like which serves for suspending corresponding webs of material or pockets. More particularly the invention is preferably a suspension device for webs of flexible material, that includes a fixing portion which permits fixing of the suspension device to or in the proximity of an edge of a flat web material, and a suspension portion which permits suspension on a profiled bar. The suspension portion desirably includes two substantially oppositely disposed and mutually facing first and second hook portions defining a respective undercut configuration, and wherein the first hook portion is movable in such a way that the undercut configuration defined by the first hook portion is at least partially opened so that the profiled bar can be introduced between the first and second hook portions into the undercut configurations, wherein after the movable first hook portion is moved back into the initial position of being disposed substantially opposite to the other second hook portion, the profiled bar is secured in the two undercut configurations. The second hook portion is a fixed and relatively short, stable hook portion and the other, first movable hook portion is substantially longer. The invention also includes a web of material as part of a transport or storage apparatus, in which receiving pockets or receiving compartments for articles to be transported or stored are formed by corresponding webs of material, wherein at least two suspension devices, as described above are mounted to a first edge of the web of material.

### CROSS REFERENCE TO RELATED APPLICATIONS

This application is a continuation of PCT Application PCT/EP2003/050825 filed Nov. 13, 2003 and designating the United States which in turn claims priority from German Patent Application 202 18 442.0 filed Nov. 27, 2002.

### BACKGROUND OF THE INVENTION

The present invention concerns a suspension device for webs of flexible material, comprising a fixing portion which permits fixing of the suspension device to or in the proximity of an edge of a flat web material, and a suspension portion which permits suspension on a profiled bar. In corresponding fashion the present invention also concerns webs of material equipped with corresponding suspension devices.

In specific terms such suspension devices are used for webs of material, for example in transport and storage apparatuses, in which the webs of material form receiving pockets or receiving compartments or however parts of such pockets and compartments. In that case adjacent webs of material can be joined together by way of an additional web of material disposed therebetween, or they can also be joined together in one piece and form U-shaped pockets. Delicate articles can be inserted between those webs of material and into the pockets which are possibly provided therebetween, wherein in a typical transport or storage apparatus a plurality of suitable compartments and pockets is formed, in which a corresponding plurality of articles can be accommodated, the articles being separated from each other by the webs of material and thus protected from damage, scratching and the like. In particular such transport and storage apparatuses are used for bodywork parts and interior trim parts of motor vehicles.

Corresponding webs of material or pockets are generally suspended in a relatively large frame or support structure. In order to be able to hang up those webs, their edges or ends are often provided with loops which are pushed on to corresponding rods or tubes. In that situation a large number of similar webs of material or pockets are often pushed with their eyes on to corresponding tubes in order to be suspended in a support structure. If one of those pockets is damaged and is to be replaced however, all other pockets which are disposed in front of or behind it have to be released from the suspension device before a fresh pocket can be suspended in place instead of the old one. It is also not possible for example for individual pockets with the articles accommodated therein to be removed from a corresponding apparatus so that for example they can be further transported in another apparatus or temporarily put into intermediate storage with the pocket.

Instead of the loops provided at the edges of webs of material, corresponding webs have occasionally also been provided with eyes which are pushed on to round bars or tubes in the same manner as the above-mentioned loops. The same disadvantage also occurs in this case, that the individual web or the individual pocket is not replaceable quickly and easily, without other webs or pockets also being released at the same time from the device, at least when the web to be replaced is not disposed at the outer edge of a row of pockets or webs.

Eyes as a suspension device also often give rise to a severely localised loading if the web of material is severely stressed or if correspondingly heavy articles are accommodated in pockets which are formed by those webs of material.

U.S. Pat. No. 4,105,268 describes a suspension device having a fixing portion and a suspension portion, wherein the suspension portion has two substantially oppositely disposed and mutually facing flexible hook portions which each define a respective hook undercut configuration and which embrace a profiled rod. Such a suspension device is suitable according to U.S. Pat. No. 4,105,2 for suspending documents (for example drawings, maps, newspapers and magazines).

### BRIEF DESCRIPTION OF THE INVENTION

In comparison with the above state of the art, the object of the present invention is to provide a suspension device which can be fixed and also released again in a simple manner to and from a profiled bar or the like which serves for suspending corresponding webs of material or pockets.

More particularly the invention is preferably a suspension device for webs of flexible material, that includes a fixing portion which permits fixing of the suspension device to or in the proximity of an edge of a flat web material, and a suspension portion which permits suspension on a profiled bar. The suspension portion desirably includes two substantially oppositely disposed and mutually facing first and second hook portions defining a respective undercut configuration, and wherein the first hook portion is movable in such a way that the undercut configuration defined by the first hook portion is at least partially opened so that the profiled bar can be introduced between the first and second hook portions into the undercut configurations, wherein after the movable first hook portion is moved back into the initial position of being disposed substantially opposite to the other second hook portion, the profiled bar is secured in the two undercut configurations. The second hook portion is a fixed and relatively short, stable hook portion and the other, first movable hook portion is substantially longer.

The invention also includes a web of material as part of a transport or storage apparatus, in which receiving pockets or receiving compartments for articles to be transported or stored are formed by corresponding webs of material, wherein at least two suspension devices, as described above are mounted to a first edge of the web of material.

### BRIEF DESCRIPTION OF THE DRAWINGS

FIG. 1 shows a side view of a suspension device according to the invention,

FIG. 2 shows a plan view of the suspension device of FIG. 1, in which however the two halves are folded away from each other,

FIG. 3 shows how the device according to the invention can be mounted to a T-shaped holding profile,

FIG. 4 shows a portion of the upper region of two webs of material which with a further web define a U-shaped pocket, wherein a respective one of the suspension devices according to the invention is mounted to the upper edges and the corner region of the webs of material,

FIG. 5 again shows a side view of corresponding pockets, in which it can be seen that a respective suspension device is mounted to the upper edge of each of the webs of material in the corner region and that mounted at the lower edge of the web of material is a further suspension device, but this time only at one end of the edge of the web of material,

FIG. 6 shows the fitment of the suspension device according to the invention at the upper edge of a web of material, wherein in addition FIG. 6 at the right again shows the upper edge of the web of material without the suspension device but with two positioning openings, and

FIG. 7 shows a perspective view of the upper region of a pocket.

### DETAILED DESCRIPTION OF THE INVENTION

The object of the present invention is attained in that the suspension portion of the device comprises two substantially oppositely disposed and mutually facing hook portions defining a respective undercut configuration, wherein a hook portion is movable in such a way that the undercut configuration defined by the hook portion is at least partially opened so that the profiled bar can be introduced between the hook portions into the undercut configurations, wherein the profiled bar, after the movable hook portion is moved back into the initial position of being disposed substantially opposite to the other hook portion, is secured in the two undercut configurations, and wherein the suspension device is characterised in that one hook portion is a fixed and relatively short, stable hook portion and the other, movable hook portion is substantially longer.

That makes it possible for the individual suspension device to be additionally mounted to or released from the profiled bar at any time and completely independently of other suspension devices mounted to the same profiled bar, insofar as the one hook portion is simply moved away, for example into a lateral bent-away position, in such a fashion that the profiled bar can be moved into and out of the region of the undercut configurations, whereas in the position in which the movable hook portion is disposed in opposite relationship to the other hook portion, the profiled bar is secured in the undercut configurations and cannot be removed therefrom.

When corresponding suspension devices are mounted to webs of material, the webs of material and/or pockets formed therefrom can be correspondingly suspended from or released from corresponding profiled bars at any time, without further pockets or suspension devices which are mounted to the same profiled bar in front of same or therebehind having to be released.

In the preferred embodiment of the invention, formed between the hook portions and by the undercut configurations formed thereby is a T-shaped recess for receiving a corresponding T profile.

It will be appreciated that the hook portions and the undercut configurations formed thereby could obviously also be defined by any other profile shapes, a T-profile being preferred in the present case for the reason that on the one hand it guarantees good stability for the profiled bar and on the other hand secured engagement with two hook portions can be relatively easily achieved in the case of a T-profile.

Desirably the at least one movable hook portion can be elastically bent away and returns without the effect of external forces back into the closed position of being disposed in opposite relationship to the other hook portion, in which a T-piece received between the hook portions is secured, that is to say cannot be released from the two hook portions.

In an alternative embodiment the movable hook portion is biased by means of a spring element into the closed position of being disposed in opposite relationship to the other hook portion.

Advantageously the movable hook portion is movable substantially in a lateral direction, that is to say perpendicularly to the plane formed by the two oppositely disposed hook portions.

For specific handling and actuation, it can be desirable if the movable hook portion is designed to project upwardly or outwardly, that is to say on the side remote from the undercut configuration, beyond the level of the fixed hook portion. That permits the movable hook portion to be relatively easily gripped or grasped in order to be able to bend it away when required. In particular the edge of the movable hook portion, which protrudes beyond the edge of the other hook portion, can then also be pressed laterally against the edge of a profiled bar until that hook portion is laterally bent away sufficiently far to permit the profiled bar to enter into the undercut region between the hook portions, whereupon the hook portion which is elastically bent away in that fashion snaps elastically back.

The fixing portion of the suspension device can have one, two or also more rows of small holes or seam holes through which can be passed threads which form a seam for connection to a web of material. Alternatively, that fixing portion can be made from a sufficiently soft but tear-resistant or tough material which can be sewn by means of an industrial sewing machine so that the fixing portion can be sewn to the web of material disposed therebeneath or laid thereupon.

Alternatively or in combination therewith the fixing portion can also be welded and/or glued to the web of material. That can advantageously be effected for example by means of a double-sided adhesive tape.

Furthermore the fixing portion can also have positioning marks which serve for alignment of the fixing portion and the entire suspension device along an edge of a web of material.

In addition, in the preferred embodiment of the invention, the material is reinforced in the region of at least one of the hook portions and more specifically preferably in the region of a stationary, non-bendable hook portion.

In addition a particularly preferred embodiment of the invention is one in which the suspension device comprises two substantially mirror-image halves, between which in the assembled condition an edge of a flexible web is accommodated and fixed. In the case of such a suspension device which is almost of a mirror-image configuration, it is preferable if a hook portion which can be elastically bent away is provided only at the one half of the suspension device which in other respects is of a mirror-image configuration, while the other half at that location has an opening. That ensures sufficient bendability and preferably elastic bendability of the at least one hook portion.

A particularly preferred embodiment of the invention is one in which the two halves are integrally connected together by one or more bending hinges. By means of the bending hinges, the two halves hold together well and in substantially mutually aligned relationship and can be easily folded together with the web of material or the edge of a web of material disposed therebetween, and they then firmly hold the web of material in a sandwich-like arrangement.

In that respect a particularly preferred embodiment of the present invention is one in which the two halves have alternately mutually inter-engaging openings and projections which provide for precise relative alignment of the two halves, even if that is already substantially achieved by virtue of the corresponding bending hinges.

A corresponding web of material which is provided as part of a transport or storage apparatus in which receiving pockets or receiving compartments for articles to be transported or stored are at least partially formed by corresponding webs of material provides that the object according to the invention is attained in that at least two suspension devices of the above-described kind are arranged or mounted to an edge of said web of material.

Preferably in that case two suspension devices are mounted along a first edge while at last one further suspension device is mounted at a further edge of the web of material, which is substantially in opposite relationship to the first edge.

In that case, the two suspension devices arranged along an edge are desirably so oriented that they are turned relative to each other through 180°, more specifically in such a way that the portions with the hook portions which can be bent away face towards each other while stronger, more stable hook portions of the suspension device are respectively disposed on the portions, which face away from each other, of the two suspension devices.

The one suspension device can then be arranged on the oppositely disposed edge of the web of material in mirror image relationship with the corresponding suspension device at the first edge.

Desirably, the suspension devices are sewn to the corresponding web of material.

In order to already provide for precise alignment during fixing of a suspension device to a web of material, a preferred variant of the invention provides that disposed at an edge of a web of material which is provided for fitting corresponding suspension devices are openings which in their shape match the projections of the suspension device or the fixing portion of the suspension device, which at the same time also form precise alignment of the two halves of the preferred embodiment.

Further advantages, features and possible uses of the present invention will be clearly apparent from the description hereinafter of a preferred embodiment and the related Figures.

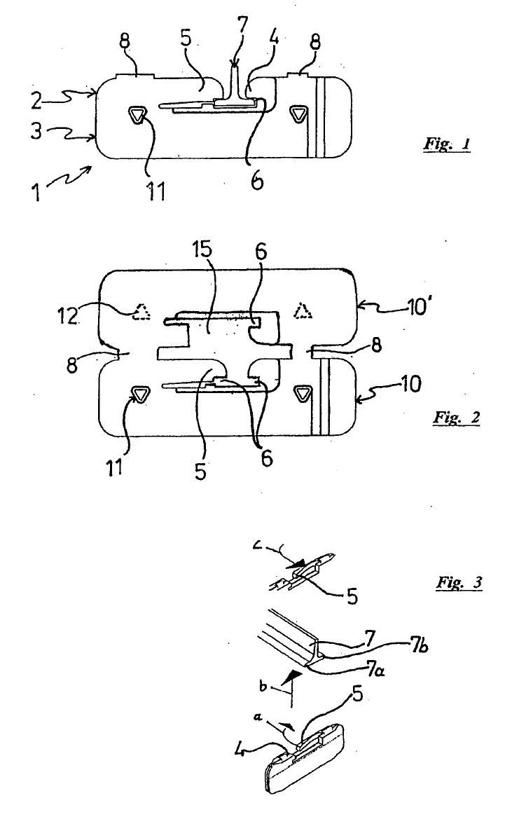

Reference may be made to FIG. 1 showing a side view of a suspension device which comprises plastic material and whose upper half defines a suspension portion 2 and whose lower half defines a fixing portion 3. The suspension portion 2 is substantially defined by two hook portions 4, 5 which face towards each other and which respectively define an undercut configuration so that an opening 6 which is of substantially a T-shaped cross-section is overall defined between the two hook portions 4, 5 and with the above-mentioned undercut configuration. As can further be seen from the view in FIG. 1, a profiled bar 7 of T-shaped profile is accommodated and secured in position. While the hook portion 4 is a strong and relatively short, stable hook portion, the hook portion 5 is substantially longer, with an undercut configuration which also extends over the T-shaped opening defining same. That configuration, in conjunction with the material from which the suspension device 1 is formed, provides that the hook portion 5 can be elastically bent away, that is to say it can be bent forwardly or rearwardly out of the plane of the paper in the view in FIG. 1.

FIG. 2 shows the same suspension device of which a side view is shown in FIG. 1, in a pivoted-open position. It will be seen in this case that the suspension device 1 comprises two halves which are of a substantially mirror-image configuration relative to each other. The two halves 10 and 10′ respectively differ essentially only in their respective fixing portions 2 and 2′. While both fixing portions 2 and 2′ have a relatively short, strong hook portion 4 and 4′ respectively, the element 10′ does not have the long flexible hook portion which is identified by reference 5 in the portion 10. Instead, a corresponding opening 15 is provided at the portion 10′. The two halves 10, 10′ are connected together by way of two bending hinges 8 and are pivoted together so that they form overall the suspension device illustrated in FIG. 1.

FIG. 3 shows the procedure involved in suspending or connecting the suspension device 1 to a profiled rail 7 of T-shaped profile. The procedure is shown in terms of its progress in an upward direction in FIG. 3.

Firstly the movable hook portion 5 is bent outwardly as indicated by the arrow a. The suspension device is then moved towards the profile rail 7, as indicated by the arrow b. That is effected in such a way that the lower region of the rail, comprising the flange portions 7a, 7b, is inserted between the firm hook portion 4 and the hook portion 5 which has been bent back. At the same time or subsequently the one flange portion 7a of the profiled rail is introduced into the undercut configuration formed by the firm hook portion 4. When the flange portions 7a, 7b rest on the bottom of the undercut configurations formed by the hook portions 4 and 5, the hook portion 5 which has been elastically bent away is allowed to snap back so that it engages over the flange portion 7b of the profiled rail 7. That then corresponds to the situation as shown in the side view of FIG. 1.

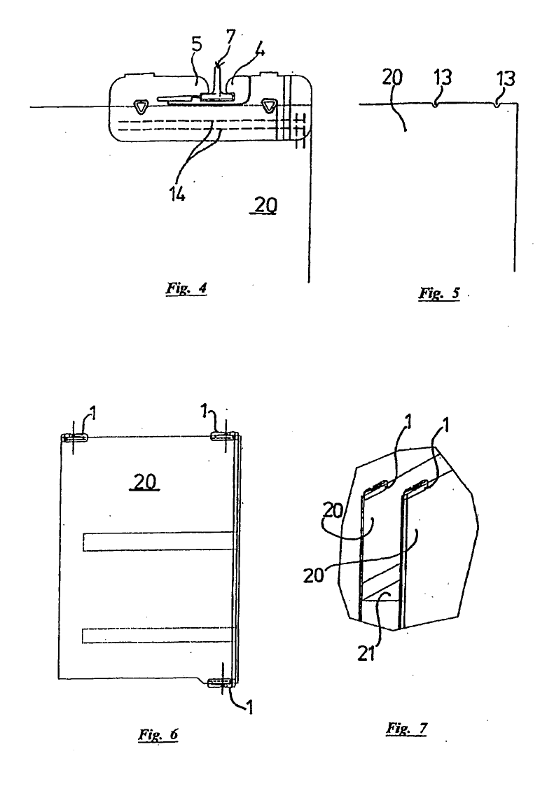

FIG. 4 again shows the suspension device of FIG. 1, how it is fixed to the upper edge of a flexible web 20.

For fixing the suspension device 1 to the edge of the web 20, the suspension device is fitted in the position shown in FIG. 2 to the edge of the web 20, in which case the triangular openings 11 which can be seen in FIG. 1 and FIG. 2 are aligned with corresponding triangular openings 13 at the edge of the flexible web 20. Provided on the half 10′ which is of a substantially mirror-image configuration with respect to the half 10, instead of the triangular openings 11, there are triangular projections 12 which are indicated in broken line in FIG. 2 and which fairly precisely fit into the triangular openings 11, without a very precise fit or indeed a press fit being an important consideration in this respect. The projections 12 and the openings 11 essentially only serve to align the two halves 10, 10′ substantially with each other in such a way that the two fixed hook portions come to lie precisely one upon the other and jointly form the fixed hook portion 4.

Alignment by means of the additional openings 13 at the edge of the flexible web 20 provides that the lower fixing portion 3 on the one hand can be sufficiently securely fixed to the flexible web 20 and on the other hand it also provides that the suspension device 1 overall is always in the same well-defined position, in relation to all webs 20.

After the two halves 10, 10′ are pivoted together, the web 20 is disposed sandwich-like between the two halves 10, 10′ of the suspension device 1, in the position shown in FIG. 4. Thereafter the lower half of the halves 10, 10′, which defines the fixing portion 3 of the suspension device, is sewn to the flexible web 20 along two seam lines 14. In addition, two additional perpendicular seam portions which can selectively also define an additional join are further indicated at the right-hand edge in FIG. 4.

At least the lower half of the suspension device 1 is made from a sufficiently soft and thin, even if tough and tear-resistant plastic material, that the corresponding seams can be produced along the lines 14 through the material of the suspension device, so that the suspension device 1 overall is firmly sewn to the edge of the web 20. Optionally if the material in question should be difficult to sew, the fixing, portion 3 could also have pre-stamped holes along the sewing perforation points so that a sewing operation would nonetheless be possible.

FIG. 6 shows the arrangement of a total of three suspension devices on a web of material 20 which is substantially rectangular and on which it is also possible to see two intermediate panel portions 21 which each make a respective connection to an adjacent web 20 so that a U-shaped pocket is defined between two adjacent webs 20 in conjunction with the connecting web portion 21, in which respect two pockets are to be seen in mutually superposed relationship in the situation illustrated in FIG. 6 while FIG. 7 shows a perspective view of the upper region of such a pocket consisting of two webs 20 and a connecting web portion 21.

As can be seen, the suspension devices 1 are arranged at the upper edge of a web 20 in mirror-image relationship with each other and near the vertical edges so that the short firm hook portions 4 are arranged on the sides of the suspension device 1, which face away from each other. A further suspension device 1 is provided at the lower edge of the web 20 in mirror-image relationship with the corresponding, upwardly arranged suspension device 1.

The relative alignment and arrangement of the suspension devices 1 along the edges of rectangular flexible webs comprising a fabric or other flexible material, wherein two adjacent webs together with a connecting web portion 21 define U-shaped pockets, provides for an overall uniform distribution of load and in particular provide that the load is predominantly carried by the short fixed hook portions 4, whereas the movable hook portions 5 which are provided only on one of the halves are only arranged on respective ones of the inner sides and have to carry less load. In addition, as the hook portions 5 are substantially longer than the short hook portions 4, the hook portions 5 can be elastically bent upwardly more easily and for that reason also are less heavily loaded.

1. A suspension device for webs of flexible material, comprising a fixing portion which permits fixing of the suspension device to or in the proximity of an edge of a flat web material, and a suspension portion which permits suspension on a profiled bar, wherein the suspension portion comprises two substantially oppositely disposed and mutually facing first and second hook portions defining a respective undercut configuration, and wherein the first hook portion is movable in such a way that the undercut configuration defined by the first hook portion is at least partially opened so that the profiled bar can be introduced between the first and second hook portions into the undercut configurations, wherein after the movable first hook portion is moved back into the initial position of being disposed substantially opposite to the other second hook portion the profiled bar is secured in the two undercut configurations, wherein the second hook portion is a fixed and relatively short, stable hook portion and the other, first movable hook portion is substantially longer.

2. A suspension device according to claim 1 wherein formed between the hook portions and by undercut configurations formed thereby is a T-shaped recess for receiving a corresponding T-profile.

3. A suspension device according to claim 1 wherein the movable hook portion can be elastically bent away and in a rest condition assumes a closed initial position in opposite relationship to the other hook portion.

4. A suspension device according to claim 2 wherein the movable hook portion can be elastically bent away and in a rest condition assumes a closed initial position in opposite relationship to the other hook portion.

5. A suspension device according to claim 3 wherein the hook portion which can be bent away is adapted to project above the level of the fixed hook portion on the side which is remote from the undercut configuration.

6. A suspension device according to claim1 wherein the fixing portion has sewing holes for making a connecting seam to the web of material to be fixed thereto.

7. A suspension device according to claim1 wherein the fixing portion comprises a sewable material.

8. A suspension device according to claim 1 wherein the fixing portion has positioning marks for alignment along the edge of a web.

9. A suspension device according to claim 1 wherein the wall thickness of the suspension portion is reinforced in the region of at least one of the hook portions.

10. A suspension device according to claim 1 wherein the wall thickness of the suspension portion is reinforced in the region of the stationary hook portion.

11. A suspension device according to claim 1 wherein it comprises two preferably substantially mirror-image halves, between which in the assembled condition the edge of a flexible web material is accommodated.

12. A suspension device according to claim 11 wherein the hook portion which can be bent away is provided only at one of the halves which in other respects are of mirror-image configuration while the other half has in that region a gap.

13. A suspension device according to claim 11 wherein the two halves are integrally connected by one or more bending hinges.

14. A suspension device according to claim 11 wherein the two halves have alternately interengaging openings and projections which provide for precise relative alignment of the two halves in the assembled condition.

15. A web of material as part of a transport or storage apparatus, in which receiving pockets or receiving compartments for articles to be transported or stored are formed by corresponding webs of material, wherein at least two suspension devices according to claim 1 are mounted to a first edge of the web of material.

16. A web of material according to claim 15 wherein at least one further suspension device comprising a fixing portion which permits fixing of the suspension device to or in the proximity of an edge of a flat web material, and a suspension portion which permits suspension on a profiled bar, wherein the suspension portion comprises two substantially oppositely disposed and mutually facing first and second hook portions defining a respective undercut configuration, and wherein the first hook portion is movable in such a way that the undercut configuration defined by the first hook portion is at least partially opened so that the profiled bar can be introduced between the first and second hook portions into the undercut configurations, wherein after the movable first hook portion is moved back into the initial position of being disposed substantially opposite to the other second hook portion the profiled bar is secured in the two undercut configurations, wherein the second hook portion is a fixed and relatively short, stable hook portion and the other, first movable hook portion is substantially longer, is mounted to an edge of the web of material, which is in opposite relationship to the first edge.

17. A web of material according to claim 15 wherein along at least one of its edges the web has openings for fittingly receiving projections of a suspension device comprising a fixing portion which permits fixing of the suspension device to or in the proximity of an edge of a flat web material, and a suspension portion which permits suspension. on a profiled bar, wherein the suspension portion comprises two substantially oppositely disposed and mutually facing first and second hook portions defining a respective undercut configuration, and wherein the first hook portion is movable in such a way that the undercut configuration defined by the first hook portion is at least partially opened so that the profiled bar can be introduced between the first and second hook portions into the undercut configurations, wherein after the movable first hook portion is moved back into the initial position of being disposed substantially opposite to the other second hook portion the profiled bar is secured in the two undercut configurations, wherein the second hook portion is a fixed and relatively short, stable hook portion and the other, first movable hook portion is substantially longer.

18. A web of material according to 16 wherein along at least one of its edges the web has openings for fittingly receiving projections of a suspension device comprising a fixing portion which permits fixing of the suspension device to or in the proximity of an edge of a flat web material, and a suspension portion which permits suspension on a profiled bar, wherein the suspension portion comprises two substantially oppositely disposed and mutually facing first and second hook portions defining a respective undercut configuration, and wherein the first hook portion is movable in such a way that the undercut configuration defined by the first hook portion is at least partially opened so that the profiled bar can be introduced between the first and second hook portions into the undercut configurations, wherein after the movable first hook portion is moved back into the initial position of being disposed substantially opposite to the other second hook portion the profiled bar is secured in the two undercut configurations, wherein the second hook portion is a fixed and relatively short, stable hook portion and the other, first movable hook portion is substantially longer.
